(19) United States
(12) Patent Application Publication
(10) Pub. No.: US 2010/0118381 A1
(43) Pub. Date: May 13, 2010

(54) Light Modulation Device

(75) Inventor: Gerald Futterer, Dresden (DE)

Correspondence Address: Saul Ewing LLP (Philadelphia), Attn: Patent Docket Clerk, 2 North Second St., Harrisburg, PA, 17101, US

(73) Assignee: SeeReal Technologies S.A., Munsbach (LU)

(21) Appl. No.: 12/555,958

(22) Filed: Sep. 9, 2009

(30) Foreign Application Priority Data
Sep. 9, 2008 (DE) 10 2008 041 913.3

(51) Int. Cl. G02B 26/00

(52) U.S. Cl. 359/291

(57) ABSTRACT

A modulation device based on electrowetting cells (EW cells), phase or amplitude or both simultaneously as a complex value of incident light is modulated in each EW cell. An EW cell includes at least one chamber with at least two fluids which are separated by an interface, external and internal electrodes which form electrode pairs activatable by control means, where at least one electrode pair controls the level of the interfaces in the chamber. The internal, mutually functionally independent electrodes inside the chamber are disposed parallel to each other such that the chamber is divided into two communicating sections with two controllable interfaces, where at least one section is transparent and forms the optical path. When at least one electrode pair is activated, the interfaces are mutually displaced such that the path length of the pencils of rays is changed compared with an initial value.

### CROSS-REFERENCE TO RELATED APPLICATIONS

This application is based on and claims priority to German Application No. DE 10 2008 041 913.3, filed on Sep. 9, 2008, the contents of which are fully incorporated herein by reference.

### BACKGROUND OF THE INVENTION

1. Field of the Invention

The field of application of the present invention includes e.g. holographic display devices, such as holographic displays which can be used to reconstruct a three-dimensional object (3D object) which consists of multiple object points. Such a holographic display is designed such that either multiple observers are simultaneously displayed the same 3D object, or that the observers can simultaneously watch different, individually selected programmes independently of each other.

2. Description of the Related Art

According to their actual requirement profile, modulator devices comprise a modulator matrix for modulating either the phase or amplitude of almost coherent light in the cells of this modulator matrix. Further, it is known in the prior art to combine two modulator matrices so to form a double modulator in order to be able to modulate both amplitude and phase of the incident coherent light simultaneously. These devices which realise a modulation with complex values allow better results to be achieved e.g. when object reconstructions in holographic displays are generated. However, in such a combined device, mutually assigned modulator cells have offsets along the optical axis or perpendicular to the optical axis which cannot be neglected, and which cause for example reconstruction errors when reconstructing a three-dimensional object.

This adverse side-effect can be overcome by integrating controllable electrowetting cells (EW cells), which can be used either in addition to or instead of the modulator matrix in the modulator device. EW cells further have the advantage that they are able to realise short switching times.

EW cells are preferably designed in the form of a chamber which is connected with control electrodes. This cell is filled with at least two immiscible fluids which differ in their refractive index, where one of the fluids is an electrically conductible medium. The interface (meniscus) between the fluids can turn for example into the form of a prism or lens for deflecting or projecting pencils of rays under the influence of an applied voltage.

For example, the volumes of the fluids can be moved from the EW cell to other spaces which are communicating with the EW cell in order to obtain the required interface shapes and positions. Such displacements are effected for example by pumps which are connected with the EW cell or by means which cause a capillary effect in at least one of the fluids.

These modulator devices with EW cells are designed to suit special applications. Used as modulators, they typically modulate only one property of the light.

Document WO 2004/027490 A1 proposes a switchable optical element with an EW cell for scanners, which comprises two fluids and a wave front modifier. The volume of the fluids is moved e.g. into annular chambers. The wave front modifier has different surface profile structures for phase modulation. Depending on the applied voltage, the surface profile of the wave front modifier is embedded either by the first or by the second fluid, which have different refractive indices. The refractive efficiency of a Fresnel zone lens depends on their fix grid periods and on the actual refractive index shift. If the refractive index of the embedding material changes, the ratio of non-diffracted light and diffracted light and thus the luminous intensity in the focus will be modified. The focus can thus not be changed continuously. The focus for the individual wavelengths (CD: 780 nm, DVD: 650 nm, blue-ray: 405 nm) lies in different depths.

Thanks to the wave front modifier, the EW cell can change phase shifts of the diffracting structures in order to optimise these for the various wavelengths. This can be used to quickly scan information which is stored in different, discrete depths in a medium. However, this arrangement is not suitable for reconstructing object points of a three-dimensional object with its variable depths.

Further, Ch. Grillet et al. describe in “Optofluidics enables compact tuneable interferometer”, published on 1 Feb. 2005, the use of fluids for optical modulation in a modified Mach-Zehnder interferometer (MZ interferometer).

A conventional MZ interferometer normally divides a pencil of rays into two spatially separated components, thus generating a phase shift between the two, which can for example be used for targeted phase modulation. In the modified MZ interferometer according to Grillet et al., the pencil of rays is split by way of aperture division. The pencil of rays propagates between the ends of two single-mode optical fibres (SMF), which include a capillary vessel which is disposed at right angles to the direction of propagation. The meniscus between a fluid and air is created in the capillary vessel, where its shape and position affect the pencil of rays which passes through it. Because one portion of the pencil of rays propagates in air while another portion propagates in the fluid, a path length difference occurs and the two portions of the beam are recombined with a phase shift. This phase shift causes the transmittance of the pencil of rays to be modified. The transmittance is lowest at a centred meniscus. The further the meniscus moves away from the centre of the pencil of rays, the greater is the transmittance. The position of the meniscus can be adjusted with the help of the electrowetting effect, which allows fast modulation.

The disadvantage of this arrangement is the occurrence of light loss caused by the reflection of the light at the boundary surfaces between the individual materials used, i.e. silicon, air, water, air, silicon. The disposition of the menisci at right angles to the direction of light propagation also causes the wave fronts to be deformed, which makes an application of this solution for amplitude or phase modulation of light in holographic display devices difficult if not impossible. It would not be possible to obtain an error-free reconstruction of an object with this arrangement.

### SUMMARY OF THE INVENTION

The present invention relates to a modulation device with a modulator matrix for modulating coherent light. The modulator matrix comprises an array of cells which work according to the electrowetting principle. An electrowetting cell comprises at least one chamber with at least two immiscible fluids which are separated by a controllable interface, and pairs of electrodes comprising internal and external electrodes, which are activated by control means. The external electrodes are disposed on the side walls of the chamber, and the internal electrodes are disposed inside the chamber. At least one pair of electrodes controls the interface.

An object of the present invention is to provide a light modulation device based on the electrowetting principle with cell sections which are able to modulate the phase or amplitude, or both simultaneously as a complex value, of incident light. The cell sections are of a simple design, fast-switching, and can be manufactured as arrays in series production. Further, the light modulation device can be designed such that the modulated light forms a plane wave front so that the device can be used in a holographic display device for the reconstruction of three-dimensional objects.

The light modulation device is based on a matrix arrangement of electrowetting cells, where an electrowetting cell (EW cell) comprises at least one chamber with at least two fluids, which are separated by an interface, and electrode pairs which can be activated by control means, where external electrodes are disposed on the side walls of the chamber and internal electrodes are disposed inside the chamber, and where at least one electrode pair controls the level of the interfaces in the chamber.

According to the present invention, this object is solved by the light modulation device in that
The internal, mutually functionally independent electrodes inside the chamber are disposed parallel to each other such that the chamber is divided by them into two communicating sections with two controllable interfaces, where at least one section is transparent and forms the light path for incident pencils of rays, and
When at least one electrode pair is activated the interfaces in the two sections have mutual positions such that the path length of the pencils of rays when passing the transparent section are modified in relation to an initial value.

In order to be able to achieve different modulations of the incident pencils of rays, the chamber is fitted with an upper cover plate and a lower cover plate, which have transparent sections in the light path. Each side wall of an EW cell is advantageously assigned with an external electrode through which the increase in temperature, which occurs when a voltage is applied, can be compensated.

According to a first embodiment of the EW cell, a phase modulation is achieved in that the change in the path length of the pencils of rays which exit the chamber corresponds with a relative phase shift. This can be realised with the help of an arrangement where an internal electrode is disposed at a given inclination relative to an external electrode, thus forming an electrode pair.

According to another embodiment for relative phase shift, one external electrode is assigned not only to one internal electrode but to multiple internal electrodes which are disposed parallel to each other. This serves to improve the capillary effect of the fluids in the section of the chamber which does not lie in the light path, so that the level of the interfaces can be displaced more quickly.

According to a first embodiment for amplitude modulation, the same components and arrangements can be used as described for the first embodiment for phase modulation. However, one fluid in the chamber must be dyed in order to influence the intensity of the pencils of rays. In addition to the relative change in the path length of the pencils of rays in the optical path, the intensity of the pencils of rays is modified, thus realising an amplitude modulation.

If both the dyed, light-absorbing fluid and the transparent fluid have the same refractive index for a given wavelength, it is only the amplitude and not the phase that is modulated.

According to a second embodiment for realising amplitude modulation, one fluid in the chamber contains a birefringent material which is given an orientation in at least one section if a voltage is applied. At the same time, the relative phase of the two polarisation components of the incident pencil of rays, namely TE and TM component, is modulated. The applied voltage changes the level of the interface in the transparent section and thus the optical path length of the pencil of rays. The absolute value of this change is generally greater than the absolute value of the change in the relative phase.

A number of means can be applied to affect the orientation of the birefringent material.

On the one hand, the birefringent material can be oriented in an electric or magnetic field which acts on the chamber. For this, the birefringent material must have an electric or magnetic dipole moment.

On the other hand, the inner surface of the chamber can be structured in order to orient the birefringent molecules. The texture which effects for example the orientation of attached liquid crystals can be applied on the inside of the cover plate and/or on the inside of the side walls of the optically active section.

Further, a polarisation state must be defined at the point of entry to the EW cell, and an analyser must be disposed at the point of exit. This requirement is fulfilled e.g. by polarisation filters which are disposed both in front of and behind the electrowetting cell.

In order to realise an amplitude modulation after the recombination of the two pencils of rays outside the EW cell, the level of the interface is adjusted by the electrode pairs in both sections such that there is a phase difference with same absolute value but different sign in each section.

The necessary recombination of two pencils of rays whose phase has been modulated only can be done with the help of an optical integrator rod at the exit of the modulating elements, i.e. of the EW cell. The length of the optical integrator rod necessary for homogenisation of the light can be reduced by a slightly diffusing surface or by diffractive and/or refractive optical elements at the point of entry of the optical integrator rod. A diffusing surface can also be provided preferably at the exit of the optical integrator rod.

According to one embodiment for complex modulation of incident pencils of rays, the device comprises a chamber with an additional, third fluid with different refractive index, and another arrangement of electrode pairs, where one arrangement of electrode pairs serves to modulate the relative phase between TE and TM polarisations and the other arrangement of electrode pairs serves to modulate the total phase. At least one of the three fluids is a birefringent substance. The relative phase between TE and TM polarisations corresponds with the amplitude of the pencil of rays as present downstream the analyser.

According to yet another embodiment of the invention, the chamber of the electrowetting cell can be designed such to follow the principle of the Mach-Zehnder interferometer.

A Mach-Zehnder arrangement represents a third embodiment for amplitude modulation in the EW cell. For this, the two sections of the chamber are transparent.

The interfaces between the two sections are adjusted by activating at least one electrode pair such that the pencils of rays pass through two different path lengths in these sections. The change in the path length within these two sections relative to an initial value results in a relative phase difference between the pencils of rays.

If the pair of electrodes adjusts the level of the interfaces in the two sections such that a phase difference of the same absolute value but with different sign is generated in each section, the pencils of rays exhibit an amplitude modulation after their recombination. The amplitude value can be adjusted to any value in a range of between zero and the maximum intensity.

Further, the Mach-Zehnder arrangement in the EW cell can be used for phase modulation.

For this, the chamber comprises two communicating sections with interfaces, where one section lies in the optical path and the other section is impermeable to light. The impermeable section is controlled by at least one pair of electrodes such that the interface which lies in the light path is moved such that a change in the path length of the passing pencils of rays is effected which corresponds to a relative phase shift for phase modulation.

A first embodiment for complex modulation is also based on a Mach-Zehnder arrangement.

Preferably, two identically designed, adjacent chambers with a Mach-Zehnder arrangement each are functionally united so to form one EW cell. Two adjacent sections of the two chambers lie in the optical path.

Pairs of electrodes additionally move the interfaces of the adjacent sections in the two chambers which lie in the optical path independently of each other in order to achieve an additional phase shift of the pencils of rays in addition to the relative phase shift which is generated in each chamber so to realise a complex modulation.

Pairs of electrodes move the interfaces in the sections in each chamber when activated by the control means and change the path lengths of the passing pencils of rays independently of each other. The pencil of rays which is formed as the sum of these two pencils of rays after their passage through the two chambers is thus modulated complexly.

According to a second embodiment for complex modulation, the Mach-Zehnder interferometer is realised in the EW cell by two mutually independently controllable adjacent chambers with three fluids each. When controlled by the control means, the interfaces of the fluids in each chamber form a coplanar plate which show different inclinations in the adjacent chambers in order to complexly modulate the passing pencils of rays.

In order to obtain a plane wave front for a holographic reconstruction of a 3D object, the transparent section can comprise means for flattening the interface. For example, a circumferential electrode can be disposed in the transparent section whose control voltage generates a contact angle of 90° between interface and side wall.

The surface of the side walls within the transparent section of the EW cell can alternatively preferably be coated in order to get a plane interface.

In order to get a plane exit wave front, a micro-lens can be disposed e.g. at the point of exit of the EW cell, where the aperture of that lens corresponds with the cross-section of the exiting pencils of rays.

The inventive modulator device based on EW cells which take advantage of capillary forces for variably adjusting given interfaces between the fluids of the EW cell boasts a number of advantages compared with prior art light modulation devices.

The individual EW cells have a simple design and can be made very small. The minimum volume of fluids which must be moved in them allows the shape and/or position of the interfaces to be changed very quickly. Thanks to their simple design, they can be manufactured inexpensively and in series production in the form of arrays in several sizes. A number of material combinations are available as fluids, depending on the actual application.

These advantages makes them applicable for modulating phase, amplitude or complex values of coherent pencils of rays in many fields of technology. They are particularly suited for holographic display devices for reconstructing a three-dimensional object which is represented by a very large number of individual object points.

### BRIEF DESCRIPTION OF THE DRAWINGS

The light modulation device according to this invention will now be explained in more detail with the help of embodiments. The accompanying drawings are schematic sectional views, where

FIGS. 1a, 1b show two embodiments of an EW cell for phase modulation of coherent pencils of rays;

FIG. 2 shows an embodiment of an EW cell for amplitude modulation;

FIG. 3 shows an embodiment of an EW cell based on a Mach-Zehnder interferometer for modulating pencils of rays;

FIG. 4 shows an embodiment of an EW cell for amplitude modulation according to FIG. 3;

FIG. 5 shows an embodiment of an EW cell for complex modulation according to FIG. 3;

FIG. 6 is a top view showing an embodiment where coplanar plates are formed in the Mach-Zehnder arrangement for complex modulation;

FIG. 7 shows an embodiment according to FIG. 5 together with an arrangement for recombining divided pencils of rays;

FIG. 8 shows a further embodiment of an EW cell for complex modulation;

FIGS. 9a, 9b are modifications of FIG. 1a; and

FIGS. 10a, 10b are modifications of FIG. 4.

### DETAILED DESCRIPTION

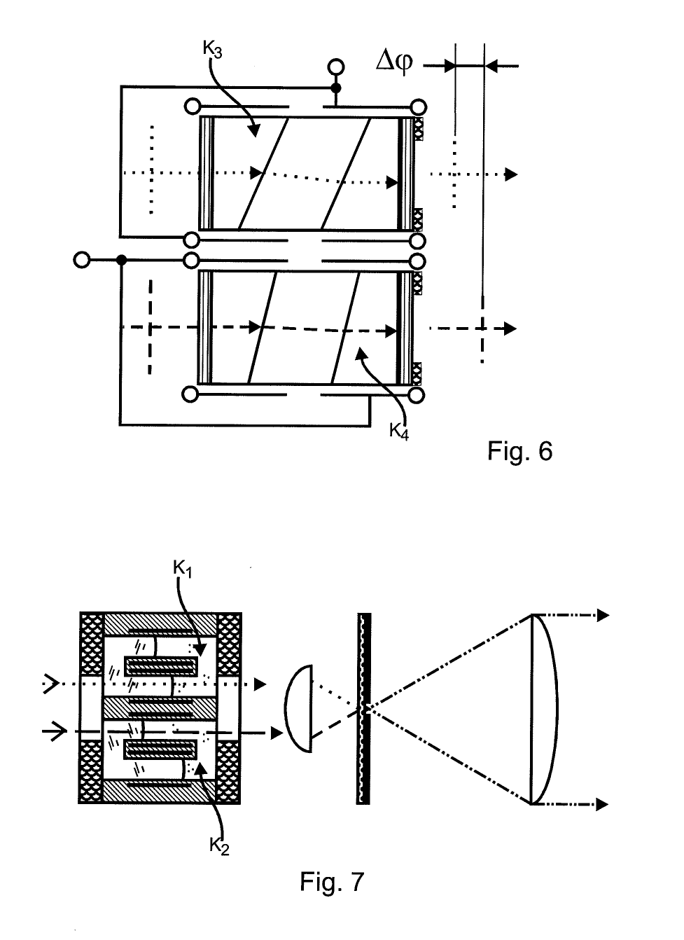

With the exception of FIG. 6, all Figures show front views of the EW cells in a simplified, schematic manner, but with all details which are essential for the comprehension of the invention. A multitude of these EW cells are arranged in a matrix so to form an array for light modulation. Further essential components of the device according to this invention are pairs of electrodes which are activated by control means. Additional components may be necessary depending on the kind of modulation.

Each EW cell comprises a chamber with internal and external electrodes, where the internal electrodes are preferably of a transparent nature. At least two immiscible fluids which differ in their refractive index are separated by an interface. A fluid can be a liquid, a gel or a gaseous medium. One fluid of two adjacent fluids is always electrically conductive and can thus be controlled by electrodes. Seen in the direction of light propagation, the first fluid is here the conductive fluid, it is characterised by a defined potential. This potential can for example be applied on the inside of a cover plate. The side of the cover plate which faces the electrically conductive fluid is then for example coated with a transparent electrode.

A change in the level of the interface in the light path shall be understood as a change in the filling level of the conductive fluid in the chamber, where said change is achieved by activating one or multiple electrode pairs. The optical path of the pencils of rays always runs through the transparent section of a chamber. The optical paths of the incident pencils of rays are indicated by arrows.

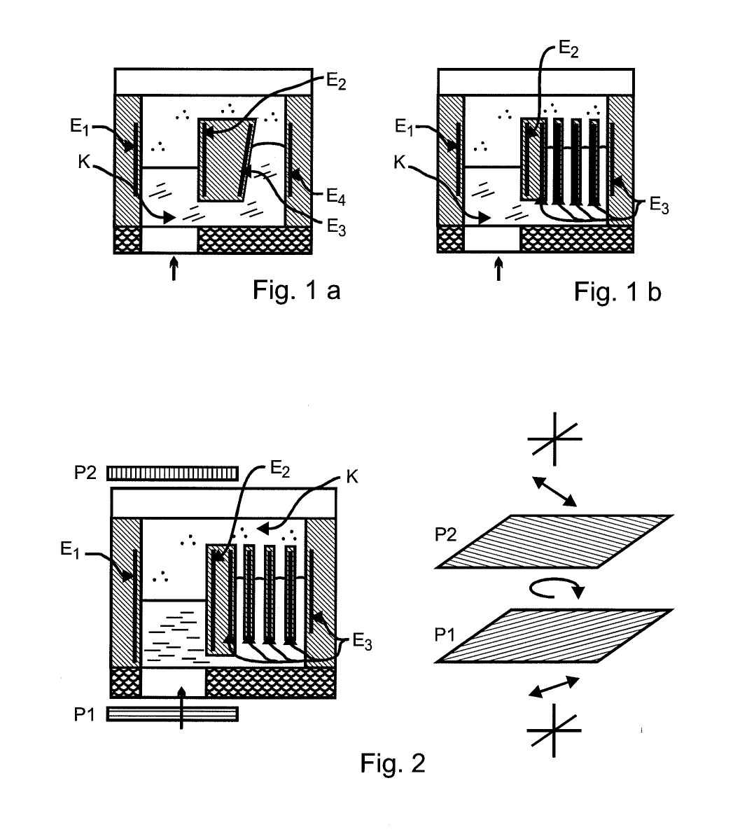

FIG. 1a shows the chamber of an EW cell in a sectional front view. The chamber comprises side walls with external electrodes E₁ and E₄, an upper cover plate and a lower cover plate. The upper cover plate is transparent, while the lower cover plate has a transparent section and a non-transparent section. An arrangement of two internal electrodes E₂; E₃ extends from one side wall to the opposite side wall, thus dividing the chamber into two sections. The fluids in the two sections are communicating. The section which is confined by the pair of electrodes E₁; E₂ lies in the optical path and represents the optically active section. The pencils of rays are prevented from entering the other section by the non-transparent section of the cover plate. Here, the internal electrode E₃ is disposed at a given inclination to the outer electrode E₄. The electrodes E₃ and E₄ form a controllable pair of electrodes. The inclination narrows the gap between the two electrodes, thus strengthening the capillary effect between them.

In FIG. 1b, multiple electrodes E₃ which are arranged in parallel replace the pair of electrodes E₃, E₄ of FIG. 1a. The electrodes are all supplied with the same voltage. Depending on the applied voltage, the level of the interface between the electrodes E3 can be varied continuously, which effects a change in the level of the interface in the optical path.

The change in the position of the interface in the optical path in FIG. 1a and FIG. 1b results for example in an increase of the portion of the optically more dense fluid in the transparent section, thus changing the path length of the pencil of rays relative to an initial value. After passing the chamber, the pencil of rays exhibits a given phase shift, which depends on the change of the path length. In both Figures, an arrow indicates the direction of propagation of the incident pencils of rays.

Each side wall of the EW cell is preferably assigned with an external electrode. A change in temperature affects the contact angle and thus the curvature of the interface between the fluids. If the applied voltage is controlled accordingly, the curvature of the interfaces can be kept constant, preferably plane, even if the temperature changes.

The EW cell shown in FIG. 1a and FIG. 1b can also be used for amplitude modulation if a dyed fluid is used. The dyed fluid can for example be a light-absorbing oil. The intensity of the passing pencils of rays then changes in dependence on the adjusted level of the dyed fluid in the chamber.

An EW cell according to FIG. 1a or FIG. 1b can also be used for amplitude modulation if the electrically conductive fluid is a birefringent substance.

The embodiment illustrated in FIG. 2 is based on the EW cell of FIG. 1b, but the first fluid is a birefringent substance. In addition, the EW cell comprises polarising components on its light entry and exit sides, e.g. a polarisation filter comprising a polariser P1 and an analyser P2. The directions of polarisation of the pencils of rays which are generated by these polarisation components are indicated by arrows.

The polariser P1 on the entry side of the chamber or EW cell serves to define the polarisation of the incident light, which can be for example linear, circular or elliptic. It will become superfluous if the incident light already has a defined polarisation when it enters the chamber. The analyser P2 at the exit of the chamber or EW cell can have any orientation. The EW cell is preferably designed such that the light has a linear polarisation beyond the birefringent fluid in a non-energised condition of the cell. The orientation of the analyser P2 must then be chosen such that the transmittance has a minimum. This has the advantage that if defects occur in the EW cell, a permanently dark cell is less disturbing than a permanently bright cell.

As described above, the incident pencil of rays is given a phase shift. A structured surface of the bottom and/or side walls of the chamber, or an electric or magnetic field serves to orient the birefringent fluid. The polariser can for example define an entry polarisation. It can be seen as the sum of a TE component and a TM component of the polarisation of the light, where the TE component and the TM component are mutually orthogonal components.

Generally, a change occurs in the optical path length in the chamber, and the absolute value of that change is greater than the absolute value of the change in the relative phase.

The orientation of the birefringent fluid, which is for example effected by an electric field applied at least to the transparent section of the chamber, causes different optical path lengths for the TE component and the TM component of the polarised pencils of rays. A change in the level of the interface in the transparent section causes a change in the relative phase between TE polarisation and TM polarisation there, thus effecting a change in the polarisation state which results from the superposition of the two. Since the analyser P2 only lets through a defined polarisation state of the pencils of light, the change of the polarisation state before the analyser P2 corresponds with a change in transmittance which is observed behind the analyser P2.

Applying an electric voltage such to cause a change in the level of the birefringent fluid in the transparent section of the chamber thus causes an amplitude modulation behind the analyser.

The EW cells of FIGS. 1a, 1b and 2 can be realised such that the optical axis lies in the optical path and forms a symmetry axis of the electrowetting cell. The transparent section of the EW cell is then for example be surrounded by a number of pumping chambers, or by a circumferential pumping chamber.

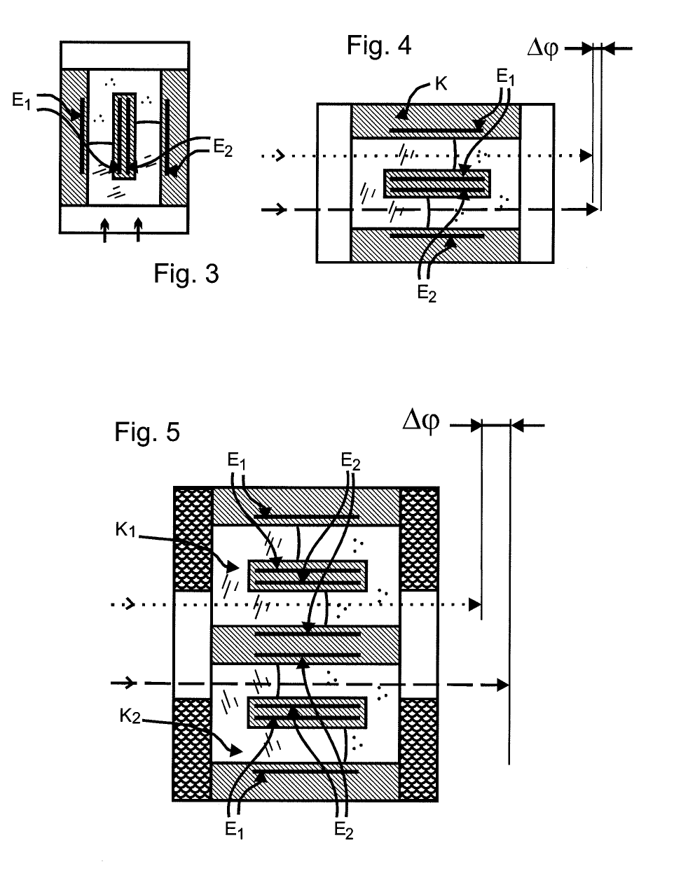

FIG. 3 shows a general embodiment of an EW cell which is based on the principle of a Mach-Zehnder interferometer, and which can be designed such that is serves for amplitude and phase modulation and for the modulation with complex values of incident coherent pencils of rays.

The EW cell with a Mach-Zehnder arrangement has a rectangular cross-section here in this example and comprises side walls, an upper cover plate and a lower cover plate. The chamber of the EW cell is divided by an arrangement of electrode pairs E₁; E₂ into two preferably identically sized sections where two immiscible fluids are communicating. The fluids are separated by an interface. A change in the level of the interface by activating the pair of electrodes of at least one section affects the level of the interface in the other section. Depending on the desired kind of modulation of the pencils of light, at least one section of the chamber is designed as a transparent, optically effective light path. A rising or falling level of the first fluid, and thus a change in the position of the interface effects a change in the path length of the pencil of rays when covering the optical path.

In order to get a phase-modulating electrowetting cell, only one section of the chamber must be transparent for incident pencils of rays in FIG. 3. The interface between the fluids is displaced specifically relative to each other in both sections when the two electrode pairs E₁; E₂ are activated. The voltage change here is equivalent to the displacement of the interface. The displacement changes the path length of the pencils of rays in the transparent section, so that the pencil of rays is given a phase shift.

In the transparent section, the voltage will only be constant if the interface is meant to be plane in that section, i.e. if no meniscus is to be generated. However, for example the pair of electrodes which embraces the non-transparent section could alternatively be activated to effect a phase modulation.

Moreover, it is also possible to keep both sections of the chamber transparent and to generate a voltage change in both sections, which can also be described as “push-pull mode”. The optical path length of the pencils of rays which pass through the electrowetting cell is mutually changed so to create the desired phase shift. An additional phase effect will occur if the interfaces in the two sections are not plane. EW cells of such a design are suitable for creating small apertures with diameters of less than 1 mm, where this phase effect can be neglected. This type of EW cell allows a higher refresh rate to be achieved.

According to FIG. 4, both sections of the EW cell are transparent for amplitude modulation. The arrangement of electrodes, which comprises two electrode pairs E₁ and E₂, is activated by control means such that a phase shift by the same absolute value is realised in the two sections by displacing the interfaces. However, the absolute value has opposing signs in the two sections. Here, the first fluid which is hit by the incident pencil of rays has a greater refractive index than the second one. Being the controlled variable, the phase shift causes the intensity to range between full superposition and extinction, depending on the applied voltage. The achieved relative phase shift is characterised by Δφ.

A complex modulation or a phase modulation can be realised with an EW cell which comprises two chambers K1 and K2 which are disposed side by side and which have a Mach-Zehnder arrangement each. This combination is shown schematically in FIG. 5.

The respective outer sections of the combined EW cell are non-transparent to light, e.g. by blackened areas in the upper and lower cover plates. The pencils of rays pass two inner, transparent sections of the chambers K1 and K2, which are separated by a partition wall. In these sections, the levels of the interfaces are positioned independently of each other by independently controllable pairs of electrodes from an initial level to different target levels. The combination of the different levels causes pencils of rays to cover different path lengths in the two optical paths. This means that a different phase shift is generated in each of the chambers K1 and K2. After their passage through the EW cell, the two pencils of rays are recombined and are complexly modulated. The complex modulation of the electromagnetic field of the light is defined by a modulation of the phase which is common to the two pencils of rays, and by a modulation of the phase difference between the two pencils of rays, the relative phase shift Δφ.

FIG. 6 shows an embodiment for complex modulation based on a Mach-Zehnder arrangement where an EW cell comprises two independently controllable, adjacent chambers K3; K4 with three fluids each. Both chambers represent optically effective, transparent sections. Two adjacent fluids in the chambers are immiscible.

The interfaces in each of the chambers K3; K4 are controlled by control means (not shown) such that they exhibit the same inclination and that the centrally situated fluid forms a coplanar plate. Two control signals are required only for each of the chambers K3; K4 to control the interfaces accordingly.

The coplanar plate in one chamber is adjusted such to have an inclination which is different from that in the other chamber. The change in inclination of one coplanar plate corresponds with a change in the optical path length of the pencils of rays in that chamber and thus with a phase shift. After their exit from the chambers K3; K4, the pencils of rays with their phase difference are superposed so to achieve a complex modulation. The resultant amplitude is defined with the help of the relative phase difference Δφ between the two transparent areas. The phase of the superposed pencils of rays can be changed without changing the resultant amplitude value by generating the same change in the optical path length in the two adjacent sections by activating both pairs of electrodes accordingly. The relative phase of the two superposed pencils of rays is thereby not changed. This makes it possible to achieve a complex modulation of the pencils of rays.

FIG. 7 illustrates another arrangement for complex modulation based on the Mach-Zehnder arrangement shown in FIG. 5. Again, the EW cell comprises two independent chambers K1; K2, each with adjustable interfaces in two adjacent transparent sections which lie in the optical path. The outer sections of the combined EW cell are non-transparent to light.

The interfaces in the sections of chamber K1 are adjusted to certain levels independently of the interfaces in the adjacent chamber K2 by individually activating the respective pairs of electrodes in those chambers. The adjusted displacement of the interfaces in the transparent sections of the two chambers K1; K2 causes the path lengths covered by the pencils of rays to be different after their exit from the EW cell. This is illustrated by the staggered arrangement of the arrows which represent the pencils of rays beyond the cover plate. The pencil of rays which is formed as the sum of the two pencils of rays is modulated complexly.

As shown in FIG. 7, after exiting the modulating EW cell, the two pencils of rays hit a telescopic arrangement of two micro-lenses which serve to recombine them. A diffusing material is disposed in the focal point of the first lens, said material preferably having an aperture on the optical axis. If the second lens has a greater focal length than the first lens (f₁<f₂), this arrangement will enlarge the cross-section of the pencil of rays (enlargement factor V=f₂/f₁). In a matrix arrangement of EW cells, this can serve to improve the fill factor of the complexly modulating EW cells. Purposefully dimensioned apodisation profiles t(x,y) of individual EW cells in conjunction with a fill factor FF of >0.7 are well suited to suppress undesired diffraction orders of the incident pencils of rays. In particular, diffraction orders which would hit an eye that is situated near a generated visibility region can be suppressed. An enlargement of the cross-section of the pencil of rays after its passage through the matrix arrangement is thus preferred.

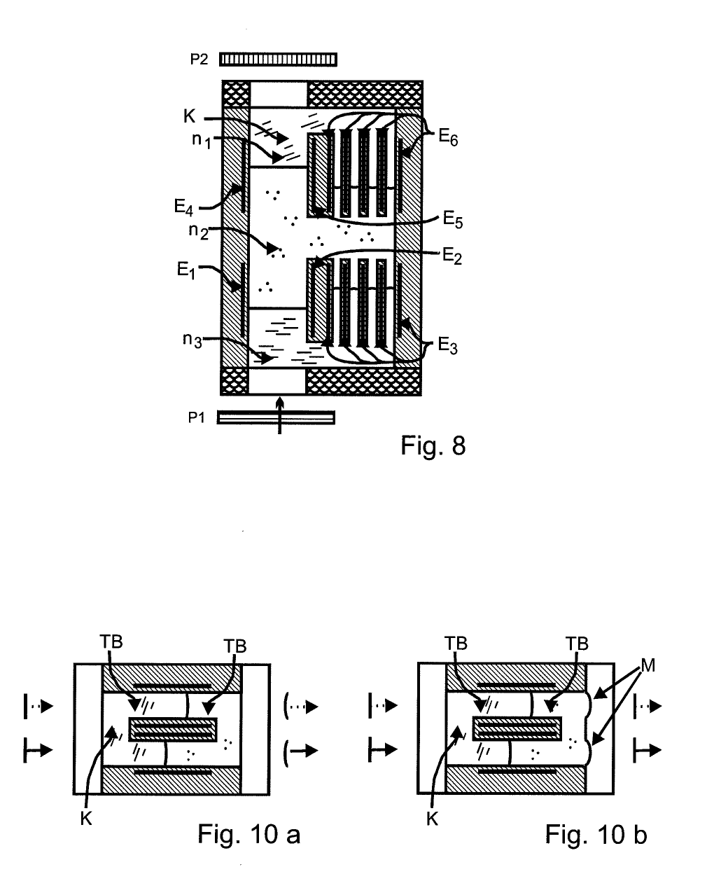

FIG. 8 illustrates another embodiment of an EW cell for complex modulation which is based on the EW cell shown in to FIG. 2.

In contrast to FIG. 2, the chamber K comprises in addition to the first and second fluid a third fluid with a different refractive index n₃, e.g. a weak solution of salt in water. One of the three fluids is a birefringent substance; here this is the first fluid with the refractive index n₁. The second fluid is non-conductive, e.g. an oil with the refractive index n₂.

In addition to the electrode arrangement with the pair of electrodes E₁; E₂ and the single electrodes E₃, another electrode arrangement with the pair of electrodes E₄; E₅ and the single electrodes E₆ is provided in the chamber K. The two electrode pairs E₁; E₂ and E₄; E₅ confine the transparent section of the chamber K and generate coplanar interfaces between adjacent fluids if they are activated. The plane interface is necessary to create a plane wave front for a holographic reconstruction. It is therefore advantageous to dispose multiple electrodes in the side walls of the EW cell, for example.

In another embodiment, the electrodes E₃ and E₆ can also be replaced by an arrangement as detailed in FIG. 1a.

A polariser P1 and an analyser P2 define the polarisation state of incident and exiting light. The pencil of rays which is incident into the lower section of the chamber as indicated by an arrow will be given a relative phase shift by the first, birefringent fluid if the electrodes E₃ are activated. This means that the phase shift is different for the TE component and the TM component. In conjunction with the analyser P2, the relative phase shift defines the amplitude with which the pencil of rays leaves the EW cell. When it passes the upper section of the chamber K, the pencil of rays will be given an additional phase shift which is identical for both polarisation components TE and TM if the electrodes E₆ are activated.

This means that the control means (not shown) activate one pair of electrodes to modulate the relative phase and the other pair of electrodes to modulate the total phase of the pencils of rays so to achieve a complex modulation of incident pencils of rays.

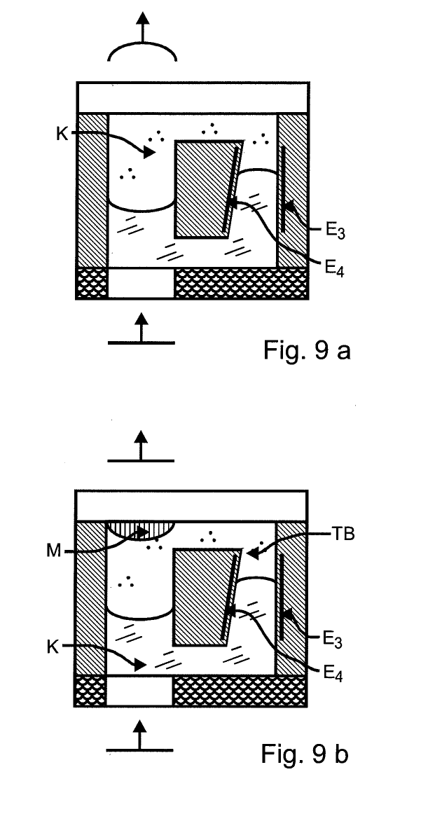

FIG. 9 and FIG. 10 show means for flattening a meniscus of the interface in the transparent section TB of a chamber K of the EW cell.

When it is activated, the pair of electrodes E₃; E₄ displaces the interface in the transparent section TB away from its initial position, thus forming a meniscus. Referring to FIG. 9a and FIG. 10a, if the incident light hits this meniscus, the wave front which exits the EW cell through the cover plate will have a curved shape. However, a plane wave front is required for a holographic reconstruction of 3D objects.

In order to flatten the meniscus in the transparent section TB, a circumferential electrode can be disposed in the side wall and controlled with a voltage such to realise a contact angle of 90° between interface and side wall. This causes a plane interface between the fluids, so that a plane wave front leaves the EW cell. Since the contact angle is temperature-dependent, the control voltage for the circumferential electrode can also be adapted to a temperature change.

In order to flatten the interface in the transparent section TB, it is also possible for the surface of the side walls to be coated or modified such that a contact angle of 90° and thus a plane interface is created.

These means can be done without if a micro-lens M is disposed at the point of exit of the transparent section TB of the EW cell, as shown in FIG. 9b. The refractive power of that lens should be chosen such to compensate the wave front curvature effected by the meniscus. The aperture of the micro-lens M is chosen as large as the cross-section of the exiting pencils of rays. When defining the aperture, the meniscus which typically occurs at operating temperature should be taken into consideration.

The micro-lens M can be disposed on the cover plate or be integrated into the cover plate. FIG. 10b shows the latter option for two transparent sections. It is also possible to use graded index lenses (GRIN lenses) to this end.

The arrows in FIG. 9 and FIG. 10 indicate the path of the pencils of rays through the EW cell. The curved and plane lines beyond the EW cells indicate the shape of the modulated pencils of rays in the Figures.

Flattening the interface is not necessary if the pencils of rays run though optical means which combine them, for example, after their passage through the EW cell. These optical means are then designed and/or arranged such to create plane wave fronts.

1. Device for light modulation with a matrix arrangement of electrowetting cells, comprising:
an electrowetting cell (EW cell) having at least one chamber with at least two fluids, which are separated by a controllable interface;
electrode pairs which can be activated by control means, said electrode pairs comprising external electrodes disposed on the side walls of the chamber and internal electrodes disposed inside the chamber, and where at least one electrode pair controls the interface, wherein:
the internal electrodes are mutually functionally independent electrodes disposed inside the chamber parallel to each other such that the chamber is divided by them into two communicating sections with two controllable interfaces, where at least one of said communicating sections is transparent and forms the light path for incident pencils of rays, and
when at least one electrode pair is activated, the controllable interfaces in the two sections have mutual positions such that a path length of the incident pencils of rays when passing the transparent section are modified in relation to an initial value.

2. Device according to claim 1 where the modified path length of incident pencils of rays which leave the chamber corresponds to a relative phase shift, which can be used for phase modulation.

3. Device according to claim 1 where an internal electrode is disposed at a given inclination to the outer electrode or where an external electrode is assigned to multiple, parallel internal electrodes in order to strengthen the capillary effect in the section of the chamber which does not lie in the optical path.

4. Device according to claim 3 where one fluid in the chamber is additionally dyed so to change the intensity of the pencils of rays.

5. Device according to claim 3 where one fluid contains a birefringent material which is given an orientation by applying a voltage said orientation at the same time modifies the path length of the incident pencil of rays, where the phases of the TE polarisation component and of the TM polarisation component of the incident pencils of rays are modulated relative to each other.

6. Device according to claim 5 where the birefringent material is given an orientation by turning on an electric or magnetic field or by structuring the inside surface of the chamber.

7. Device according to claim 5 where there is a defined polarisation state at the point of entry to the EW cell, and where an analyser is disposed at the point of exit of the EW cell.

8. Device according to claim 5 where the level of the interface is positioned by the electrode pairs in both sections such that there is a phase difference with same absolute value but different sign in each section, so that an amplitude modulation is realised by the recombined pencils of rays with this phase difference after their passage through the two sections.

9. Device according to claim 5 where a matrix of oriented polariser strips is additionally disposed at the point of entry, and where a diffuser means in conjunction with a optical integrator rod and an analyser are disposed at the point of exit of the EW cell, in order to additionally generate two differently polarised states of the pencils of rays so to achieve amplitude modulation.

10. Device according to claim 1 where the chamber of the electrowetting cell is for light modulation designed such to follow the principle of the Mach-Zehnder interferometer and where the transparent section of the chamber includes means for flattening the interface.

11. Device according to claim 10 where the chamber comprises two communicating sections with interfaces, where one section lies in the optical path and the other section is non-transparent for light and controlled by at least one pair of electrodes such that the interface which lies in the optical path is moved such that a change in the path length for the passing pencils of rays is effected which corresponds with a relative phase shift for phase modulation.

12. Device according to claim 10 where the two sections of the chamber which lie in the optical path realise an amplitude modulation when they are controlled by an electrode pair.

13. Device according to claim 11 which in conjunction with an additional, identical chamber forms an EW cell where pairs of electrodes additionally displace the interfaces of adjacent sections in the two chambers which lie in the optical path independently of each other in order to achieve an additional phase shift of the pencils of rays in addition to the relative phase shift which is generated in each chamber so to realise a complex modulation.

14. Device according to claim 10 where the Mach-Zehnder interferometer is realised in the EW cell by two mutually independently controllable adjacent chambers with three fluids each where, when controlled by the control means, the interfaces of the fluids form a coplanar plate in each chamber, said coplanar plates showing different inclinations in adjacent chambers in order to modify the path lengths of the passing pencils of rays and to realise a complex modulation.

15. Device according to claim 7 which for a complex modulation of incident pencils of rays additionally comprises a third fluid of a birefringent substance and another arrangement of electrode pairs, where one arrangement of electrode pairs serves to modulate the relative phase between TE and TM polarisations and the other arrangement of electrode pairs serves to modulate the total phase.

16. Device according to claim 10 where a circumferential electrode is provided in the transparent section whose control voltage generates a contact angle of 90° between interface and side wall.

17. Device according to claim 1 where in order to get a plane exit wave front a micro-lens is disposed at the point of exit of the EW cell, where the aperture of that lens corresponds with the cross-section of the exiting pencils of rays.
